(19) United States
(12) Patent Application Publication
(10) Pub. No.: US 2016/0097362 A1
(43) Pub. Date: Apr. 7, 2016

(54) VARIABLE AREA ORIFICE FOR AN ENGINE

(71) Applicant: Hamilton Sundstrand Corporation, Charlotte, NC (US)

(72) Inventor: Kerry M. Peters, Belvidere, IL (US)

(21) Appl. No.: 14/507,033

(22) Filed: Oct. 6, 2014

(51) Int. Cl. F02M 63/00; G05D 7/01; F16K 31/122

(52) U.S. Cl. CPC F02M 63/0056; F02M 63/0015; F16K 31/1221; G05D 7/0146

(57) ABSTRACT

A flow control system for a fuel includes an adjustable speed control valve configured to control a flow of fuel. A variable area orifice is arranged upstream of the speed control valve and is configured to control the flow of the fuel to the speed control valve. A flow control system for a turbine fuel and a method of controlling fuel flow are also disclosed.

### BACKGROUND OF THE INVENTION

This application relates to a variable area orifice for an engine.

An engine includes a turbopump, a nozzle, and a turbine. Liquid hydrogen fuel entering the turbopump is compressed and delivered through a nozzle, which vaporizes the liquid hydrogen into a high-pressure hydrogen gas. The high-pressure hydrogen gas expands through the turbine section and exits the engine through an exhaust.

Engines generally operate at or below a certain maximum speed. The speed of the turbines can be modulated by a speed control valve, which controls the flow of fuel to the turbine, so as not to exceed the maximum.

In some instances, the engine is required to operate at speeds approaching the maximum speed. This requires very high flowrates of fuel to be fed to the turbine. When the engine is signaled to slow down, the speed control valve must respond quickly enough to adequately control the very high flowrate in order to prevent overspeeding.

### SUMMARY OF THE INVENTION

A flow control system for fuel includes an adjustable speed control valve configured to control a flow of fuel. A variable area orifice is arranged upstream of the speed control valve and is configured to control the flow of the fuel to the speed control valve. A method is also described.

These and other features may be best understood from the following drawings and specification.

### BRIEF DESCRIPTION OF THE DRAWINGS

FIG. 1 schematically shows an engine with a flow control system.

FIG. 2A shows a side view of a variable area orifice of the flow control system of FIG. 1.

FIG. 2B shows an opposite side view of the variable area orifice of FIG. 2A.

FIG. 3 shows a phantom view of the variable area orifice of the flow control system of FIGS. 1-2B in a housing.

FIG. 4 shows a section view of the variable area orifice of the flow control system of FIGS. 1-3.

### DETAILED DESCRIPTION

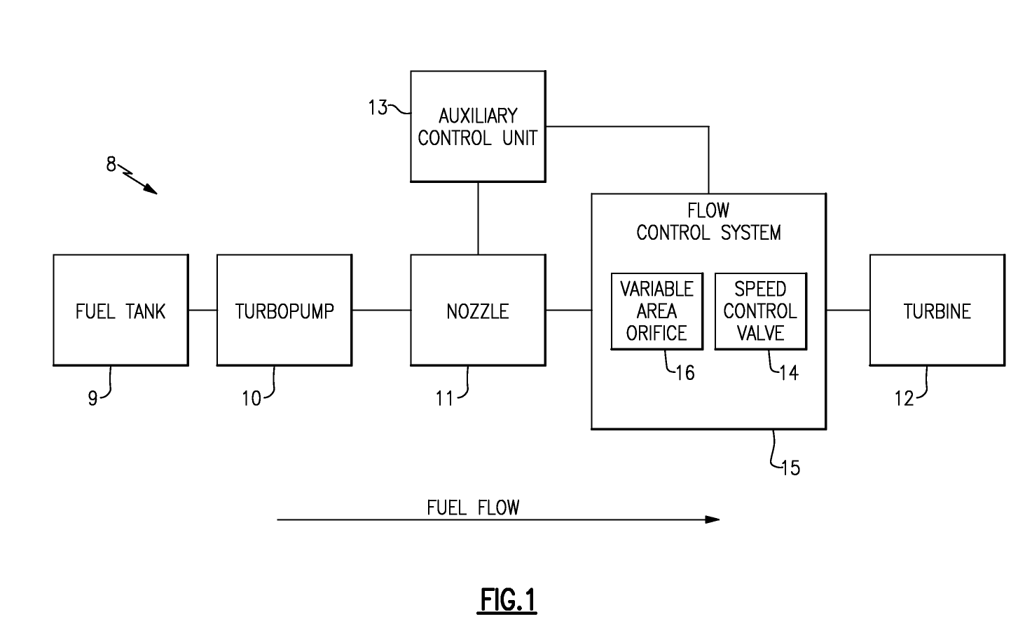

FIG. 1 schematically shows an engine 8. The engine includes a fuel tank 9, a turbopump 10, a nozzle 11, and a turbine 12. Liquid hydrogen entering the turbopump 10 from the fuel tank 9 is pressurized and vaporized through the nozzle 11 to generate a high-pressure hydrogen gas flow. The hydrogen gas flow (“fuel”) is then passed through the turbine 12. A controller such as an auxiliary control unit 13 controls the flow of liquid hydrogen from the fuel tank 9. In one example, the auxiliary control unit 13 provides a pulsed flow of liquid hydrogen to the turbopump 10.

The turbine 12 may include a fixed area nozzle (not shown). In this case, the auxiliary control unit 13 is the sole modulator of fuel pressure throughout the engine 8 by modulating the flowrate of liquid hydrogen that is vaporized. That is, the pressure differential on either side of the turbine 12 depends only on the amount of fuel exiting the nozzle 11.

A flow control system 15 for the engine 8 fuel includes a speed control valve 14 and a variable area orifice 16. The speed control valve 14 is in this example an on/off type, so that the speed control valve 14 is only capable of being in an open position and a closed position, with no intermediate positions. The speed control valve 14 can be controlled by, for instance, a mechanical governor or an electrical controller. In this example, the variable area orifice 16 is upstream from the speed control valve 14. Thus the variable area orifice 16 controls the flow of fuel from the nozzle 11 to the on-off type speed control valve 14.

When the flowrate of the fuel flowing to the turbine 12 is very high, the variable area orifice 16 provides an extra measure of protection (in addition to the speed control valve 14) to ensure that the engine 8 does not over-speed. For example, there may be a period of operation where the flowrate of fuel to the engine 8 is required to be high so that the engine 8 operates at a speed approaching its maximum speed. The auxiliary control unit 13 may determine that the engine 8 should operate at a slower speed.

At some point, the auxiliary control unit 13 sends the speed control valve 14 a signal to slow the speed of the turbine 12 by reducing the flowrate of fuel. The auxiliary control unit 13 may also send such a signal to the turbopump 10. The engine 8 may operate at an undesirably high speed for a period of time if the speed control valve 14 is not able to respond quickly enough. The variable area orifice 16 modulates flow of fuel to the speed control valve 14 so that a slow response time of the speed control valve 14 does not lead to over-speeding of the engine 8.

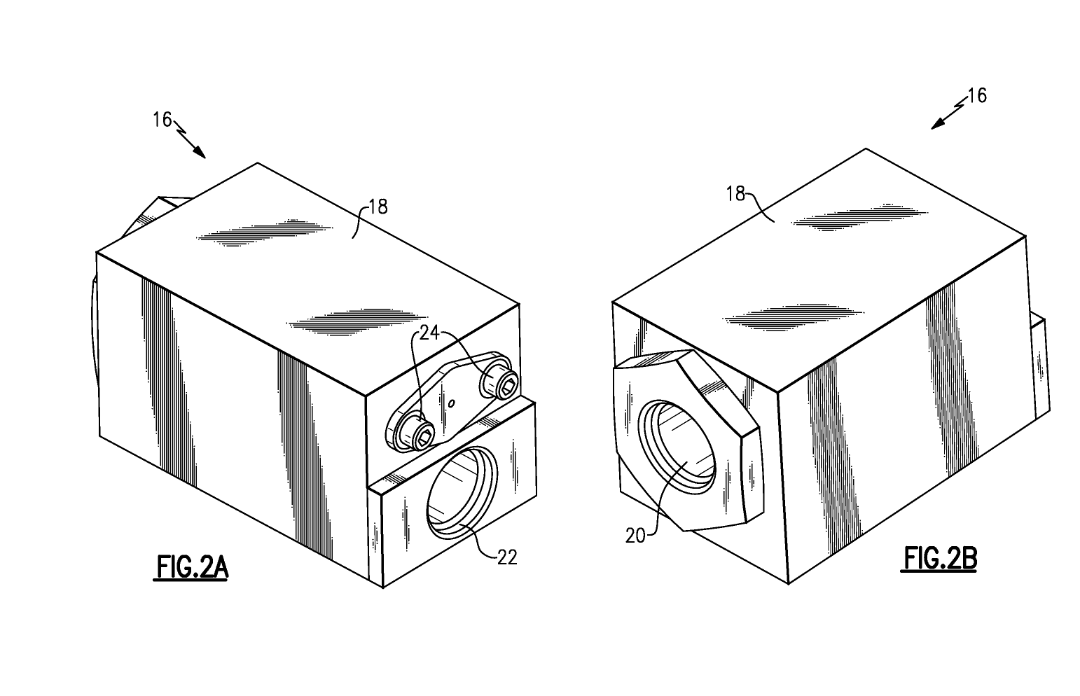

FIGS. 2A and 2B show opposite sides of the variable area orifice 16. The variable area orifice 16 incudes a housing 18, an inlet 20 receiving fuel from the nozzle 11 (FIG. 1), an outlet 22 sending fluid to the turbine 12, and vents 24.

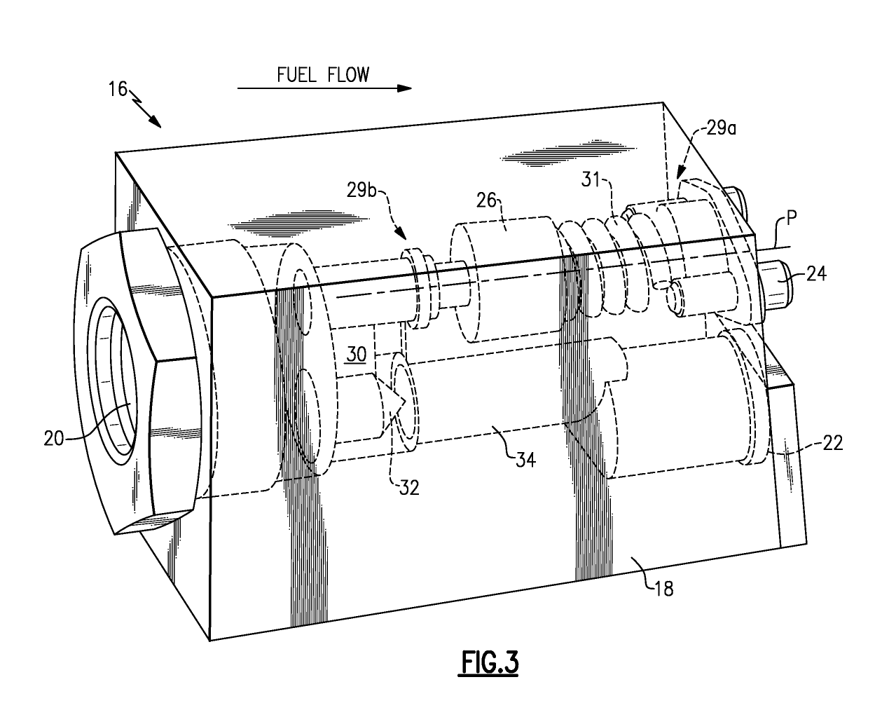

FIG. 3 shows a view of the variable area orifice 16 with the housing 18 shown in phantom.

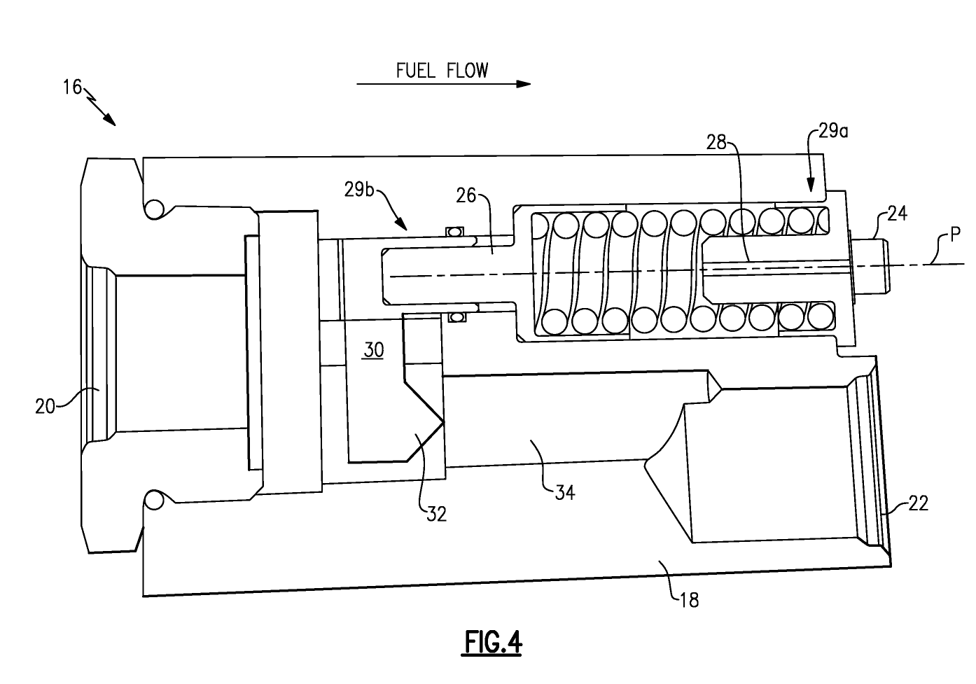

FIG. 4 shows a section view of the variable area orifice 16. The variable area orifice 16 includes a spring-loaded piston 26 in fluid communication with the vents 24 via an orifice 28 at a first end 29a of the piston 26 adjacent a spring 31. Thus the piston 26 is vented to low pressure outside the housing 18.

The piston 26 further includes an arm 30 extending perpendicular to the piston 26 from an opposite end 29b. The arm 30 includes a conical pintle 32 extending parallel to the piston 26 toward the spring end 29a. An orifice 34 is adjacent the pintle 32 and in fluid communication with the outlet 22.

In operation, the piston 26 moves in response to the pressure of fuel in the housing 18 along its axis P by the spring 31. The pressure of fuel entering the housing 18 is modulated by the auxiliary control unit 13. That is, forces generated by the flow of fuel through the housing 18 with respect to the forces generated by the spring 31 on the piston 26 determine the positioning of the piston 26 and consequently the arm 30 and pintle 32. At a pre-determined fuel pressure in the housing 18 (depending on the flow of fuel from the nozzle 11 to the variable area orifice 16), the pressure on the piston 26 surface exceeds the piston spring 31 preload and moves the piston 26, depending on the rate and/or preload of the spring 31.

As the arm 30 and pintle 32 move towards the orifice 34, the pintle 32 moves into and incrementally blocks the orifice 34 such that the area through which fuel can flow through the outlet 22 decreases. As the arm 30 and pintle 32 move away from the orifice 34, the pintle 30 moves out of and incrementally opens the orifice 34 such that the area through which fuel can flow through the outlet 22 increases. Thus the variable area orifice 16 modulates the flow of fuel before it reaches the speed control valve 14 (FIG. 1) to ensure that the engine 8 does not over-speed.

When the auxiliary control unit 13 sends a signal to slow down the engine 8, the flow of liquid hydrogen from the fuel tank 9 through the turbopump 10 and nozzle 11 is reduced, and the speed control valve 14 is signaled to reduce the flow of fuel to the turbine 12. There may be a time delay after the auxiliary control unit 13 reduced the flow of liquid hydrogen to the turbopump 10 and before the flow of fuel to the turbine 12 is reduced. If the speed control valve 14 does not respond quickly enough in this interim time, the engine 8 may over-speed. The variable area orifice 16 upstream from the speed control valve 14 is configured to modulate flow of fuel from the nozzle 11 to the speed control valve 14 such that even a slow response time of the speed control valve 14 does not cause the engine 8 to over-speed, as was described above.

Variables including the orifice 34 area, the pintle 32 geometry (including shape and/or dimensions), the spring 31 rate and preload, and the ratio of the orifice 34 area to the inlet 20 and/or outlet 22 area can be designed to match the required fuel inlet pressure range and fuel flow rate requirements to the turbine 12.

Although embodiments of this invention have been disclosed, a worker of ordinary skill in this art would recognize that certain modifications would come within the scope of this disclosure. For that reason, the following claims should be studied to determine the true scope and content of this disclosure.

1. A flow control system for a fuel, comprising:
an adjustable speed control valve configured to control a flow of fuel; and
a variable area orifice arranged upstream of the speed control valve and configured to control the flow of the fuel to the speed control valve.

2. The flow control system of claim 1, wherein the variable area orifice includes a piston configured to move a pintle with respect to an orifice to block or open the orifice.

3. The flow control system of claim 2, wherein the pintle is conical.

4. The flow control system of claim 2, wherein the pintle is configured to be at least a partially received in the orifice.

5. The flow control system of claim 4, wherein the pintle is moved by the piston via an arm extending perpendicular to an axis of movement of the piston.

6. The flow control system of claim 2, wherein the pintle is moved by the piston via an arm extending perpendicular to an axis of movement of the piston.

7. The flow control system of claim 2, wherein the piston is spring-loaded.

8. The flow control system of claim 7, wherein the piston is configured to move in response to a pressure of the fuel flow.

9. The flow control system of claim 1, further comprising a turbine downstream of the adjustable speed control valve, the turbine receiving the fuel.

10. The flow control system of claim 1, further comprising a controller configured to control the speed control valve.

11. A method of controlling a flow of fuel, comprising:
providing a fuel to a variable area orifice configured to control a flow of the fuel;
providing the fuel to an adjustable speed control valve arranged downstream of the variable area orifice; and
selectively restricting the flow through the variable area orifice such that the speed control valve response time maintains the flow below a predetermined flowrate.

12. The method of claim 11, further comprising moving a piston in the variable area orifice in response to a pressure of the fuel.

13. The method of claim 12, further comprising moving a pintle with respect to an orifice by the piston.

14. The method of claim 13, wherein the orifice is incrementally blocked or opened by movement of the pintle.

15. The method of claim 11, further comprising providing the fuel to a turbine subsequent to providing the fuel to the adjustable speed control valve.
